(19) United States
(12) Patent Application Publication
(10) Pub. No.: US 2002/0055937 A1
(43) Pub. Date: May 9, 2002

(54) Immigration case management system

(76) Inventor: Gregory G. Walther, San Francisco, CA (US)

Correspondence Address: Lawrence D. Graham, Esq., Black Lowe & Graham, PLLC, 816 Second Avenue, Seattle, WA, 98104, US

(21) Appl. No.: 09/938,626

(22) Filed: Aug. 24, 2001

Related U.S. Application Data
(60) Provisional application No. 60/227,736, filed on Aug. 24, 2000.

(51) Int. Cl. G06F 17/60

(52) U.S. Cl. 707/104.1; 705/1

(57) ABSTRACT

A method and system for the automation of tasks in managing immigration case files by attorneys. A user interface component interacts with a user through a directory tree listing to accept requests and to take appropriate action in response to those requests. A data access component uses SQL (structured query language) commands to create connections to the underlying database. The centralized SQL commands are used to create general reports and to create the data presented in the directory tree listing for the user interface component. A business logic component employs software classes to control the logic for processing immigration information.

### PRIORITY CLAIM

This application claims priority from U.S. Provisional Application Ser. No.60/227,736 filed Aug. 24, 2000, Attorney Docket No. VISA-1-1001.

### FIELD OF THE INVENTION

This invention relates generally to the automation and the management of immigration case files.

### BACKGROUND OF THE INVENTION

Congress recently stated in its Senate H-1B Report to the “American Competitiveness Act” that companies across America are faced with severe high skill labor shortages that threaten their competitiveness. As the United States economy increasingly becomes a global one, the ability to quickly transfer and hire employees from outside the United States is a key for the continued success of corporate America. The Department of Labor projects that the United States economy will produce more than 130,000 information technology jobs in each of the next 10 years, for a total of more than 1,300,000. The severe shortage of skilled workers, particularly in technological fields, and the need to develop and sell goods and services in a world market, has created an intense demand for business immigration services. As the number of “foreign” workers employed in the United States increases, the complexities of managing a multi-national workforce in the United States will continue to increase as well. Compliance with onerous rules and regulations of the U.S. immigration laws creates time-consuming and labor intensive operations associated with traditional immigration document processing and immigration status tracking by human resources professionals, hiring managers, and corporate legal departments.

The current immigration legal processing of a foreign national employee can take up to six months from the time the employee is made an offer to the time the employee is placed on the United States employer's payroll. One of the major impediments to efficient management of data in immigration is the constant monitoring of an employee's immigration status as well as any additional family member's immigration status to avoid civil or monetary penalties for the employer and possibly severe negative consequences for the employee.

For a given case, a law office may represent many clients, each with differing status. Should an employer terminate the foreign national or make other business-related decisions regarding employment, the immigration status and that of family members could be significantly compromised. In addition, a foreign national must first get authorization from the U.S. government in order to change employers. Finally, all of the legal work necessary to handle these issues and the maintenance of the legal status must be done by the company and the company's attorney. Any time the personal immigration status is needed, the company and the company's attorney must be contacted. At the same time, many foreign nationals who are on temporary visas may be found in violation of their visa status in the event an employer transfers them to another worksite. Recent legislation such as the Illegal Immigration Reform and Immigrant Responsibility Act of 1996 (IIRAIRA) makes the consequences of immigration violations more severe. For example, a foreign national who has remained in the United States for more than 6 months beyond the period authorized may be prohibited from returning to the United States for 3 years or 10 years, depending on the amount of overstay. To further complicate matters, immigration officers (INS) often give erroneous expiration dates on the entry documents given to foreign nationals when they enter the United States. Therefore, it is not uncommon for a foreign national who had previously been approved for a 3-year stay to be given a much shorter period after returning from an international trip. If this error is not discovered in a timely manner, the foreign national could be inadvertently barred from the United States. Because there are so many time critical deadlines and priority dates, the immigration process could be greatly improved by automating the case handling and documentation preparation.

Typical systems in the past have been insufficient for a variety of reasons. Relational databases are a collection of tables each having a unique name. The database scheme includes the names of tables and the names of fields within each table, and the attributes of each field (character, numeric, text, etc.). Despite the benefits of relational databases, existing case management systems for immigration law offices tend to use simpler, hierarchical databases. However, those database systems are limited in their use. Without a well-designed artificial intelligence enhanced case-tracking database, the case management system for immigration law offices are unsuitable for use in tracking time critical petition deadlines, expirations, and priority dates. Without the ability to efficiently respond to inquiries, track key events, or produce various reports, such systems have provided limited benefits. Furthermore, without the scheduling tools to provide daily tasks list and reminders to manage time effectively, such systems in the past have had limited commercial success.

Therefore, in light of these problems, there is a need for a method and system to comply with the restrictive employment-based immigration laws, allow companies to prepare the proper filings, and accelerate start dates for key foreign national hires. Furthermore, there is a need for automation of tasks in managing the immigration case files by attorneys.

### SUMMARY OF THE INVENTION

The present invention solves the above described problems by providing a method and system for the automation of tasks in managing immigration case files. The electronic database manager includes a relational database having a number of tables and a case management program for interfacing with a user to receive data, manage the data, and generate reports from the data. According to one actual embodiment of the invention, a method and system for automation of tasks in managing immigration case files is provided via a user interface component for comprehensive tracking of individual and corporate clients. Moreover, the present invention provides a method and system for defining projects to track key events of petitions, applications or any other project types. In accordance with further aspects of the invention, a visual timeline is also provided for simplifying the tracking of projects.

In accordance with other aspects of the invention, a user interface component, a data access component, and a business logic component are provided. The user interface component is a multiple document interface that provides a user with a visual interface of a tree view directory on one portion of a display screen and a detailed view on another portion of the display screen. The user interface component primarily interacts with the user from the tree view directory, accepts the user requests, and takes appropriate action in response to the user requests. The directory is preferably a tree view control loaded from an XML document generated by the business logic component. The business logic component will be described in more detail below.

In accordance with still further aspects of the invention, the main article types such as person, organization, project, site, document, and page each have a specialized display screen and edit screens to allow a user to create the articles. In addition, there are also “wizards” that guide a user step-by-step through a process of adding articles.

In accordance with yet other aspects of the invention, a centralized Browse screen is provided as a grid control to allow users to manipulate data for reports. Data for reports are accessed through the directory tree view with headers that correspond to a data set. For example, the Persons header, if clicked, causes a report of data for persons to appear on the Browse screen. Once a user has finished manipulating the data, the XML document is passed to an HTML page, where it may be saved, printed, or exported to Word, Excel or a web browser.

In accordance with still another aspect of the invention, Projects are tracked through the use of “timelines.” Timelines have both “target dates” and “actual dates.” The user can create timeline definitions using a special Admin Timelines screen, then Link the timeline definitions to certain project types. More than one timeline definition may be linked to a project type. Timeline definitions consist of events that a user defines. All timelines have a least five events: open, prep, file, dec, and done. When a user creates a specific project, the user can indicate which timeline definition to use for that project type. A timeline for the project is then created using the timeline definition as a template. In addition to tracking dates, timelines trigger specific actions to occur at certain events. These actions include, for example, updating a person's status, opening a new project, or sending an email.

In accordance with still further aspects of the invention, when adding a new record for a new client, the user has the option of using a questionnaire which is an HTML form. The questionnaire is emailed to the user's client or employee (or any other location) to be completed. Once the questionnaire is filled out by the client or employee, the questionnaire is returned to the originating user, where the data can be loaded into the database.

In accordance with yet another aspect of the invention, the data access component consists of classes or objects mostly of SQL statements, to create connections to the underlying databases and database tables. The data access component also handles the routines specific to the article types, and includes centralized routines for getting recordsets that are the results of a query, SQL stored procedures for general reports that appear in the Browse screen, SQL stored procedures to generate the tree view Directory, and software procedures specific to creating links that are the relationships between the Articles.

In accordance with further aspects of the invention, the business logic component comprises software classes or objects to control the logic for processing immigration information. Generally, the business logic component retrieves the disconnected recordsets through batch updates and stores the data in properties within the database tables. The business logic component comprises software objects for defining each of the Articles (person, project, organization, site, document, and page). When a new article is created, the new article object is assigned a unique DID (directory identification) number and is stored into the directory table within the database. In addition to the Article class object, the business logic component comprises other class objects for Directory, Browse, and HTML. The Directory class object comprises software methods pertaining to the directory tree view. The Browse class object comprises software methods in conjunction with the Browse screen and the HTML class object comprises methods for generating the HTML reports.

In accordance with still further aspects of the invention, a method, a computer-controlled apparatus, and a computer-readable medium containing instructions are also provided for the automation of tasks in managing immigration case files, preferably by attorneys or other professionals practicing in immigration law.

### BRIEF DESCRIPTION OF THE DRAWINGS

The preferred and alternative embodiments of the present invention are described in detail below with reference to the following drawings.

FIG. 1 is a FIG. 1A is a block diagram showing an exemplary system 10 for automation and management of immigration case files of client information retrieved from a remote client server and/or a local client server in accordance with the present invention;

FIG. 1B is a block diagram of a general purpose computer in accordance with the present invention;

FIG. 2 is a data flow diagram illustrating an actual embodiment of the present invention in accessing the data from the database tables for the software components to automate the management of immigration case files;

FIG. 3 is a flowchart setting forth the recursive logic of the user interface component in accordance with the present invention;

FIG. 4 is a flowchart setting forth the continued recursive logic of FIG. 3 user interface component in accordance with the present invention;

FIG. 5 is a flowchart setting forth the detailed logic of managing cases of the user interface component in accordance with the present invention;

FIG. 6 is a flowchart setting forth the recursive logic of the process of entering information into the database of managing cases of the user interface component in accordance with the present invention;

FIG. 7 is a flowchart setting forth the detailed logic of define project of the process of entering information into the database of managing cases of the user interface component in accordance with the present invention;

FIG. 8 is a diagram of the relational database tables—directory, links, and link types for storing the articles—persons, organizations, projects, sites, documents, and pages in accordance with the present invention;

FIG. 9 is a diagram of the relational database tables having a unique directory identification reference number, attorney name and/or assistant name linkages in accordance with the present invention;

FIG. 10 is a diagram of the relational database tables having person name linkages in accordance with the present invention;

FIG. 11 is a diagram of the relational database tables having organization linkage in accordance with the present invention;

FIG. 12 is a diagram of the relational database tables having project linkages in accordance with the present invention;

FIG. 13 is a screen shot of the Home Screen in accordance with the present invention;

FIG. 14 is a screen shot of Reminders for the day in accordance with the present invention;

FIG. 15 is a screen shot of managing cases in accordance with the present invention;

FIG. 16 is a screen shot of the Status Document Expiration in accordance with the present invention;

FIG. 17 is a screen shot of Projects Due in accordance with the present invention;

FIG. 18 is a screen shot of a particular project timeline in accordance with the present invention;

FIG. 19 is a screen shot of Next Events of Projects Due in accordance with the present invention;

FIG. 20 is a screen shot of Company Data in accordance with the present invention;

FIG. 21 is a screen shot of Agencies in accordance with the present invention;

FIG. 22 is a screen shot of adding documents or another application using the Link button in accordance with the present invention;

FIG. 23 is a screen shot of creating a custom page of user-defined fields in accordance with the present invention;

FIG. 24 is a screen shot of rearranging the order in which items appear by applying filters to a subset of data in accordance with the present invention;

FIG. 25 is a screen shot of adding a new person, organization, or project of the process of entering information into the database in accordance with the present invention;

FIG. 26 is a screen shot of entering employer-related information of the process of entering information into the database in accordance with the present invention;

FIG. 27 is a screen shot of entering contact information of the process of entering information into the database in accordance with the present invention;

FIG. 28 is a screen shot of entering beneficiary information of the process of entering information into the database in accordance with the present invention;

FIG. 29 is a screen shot of entering status document information of the process of entering information into the database in accordance with the present invention;

FIG. 30 is a screen shot of entering further information (e.g. assigning attorney) of the process of entering information into the database in accordance with the present invention; and

FIG. 31 is a screen shot of adding additional family members, projects and saving of the process of entering information into the database in accordance with the present invention.

### DETAILED DESCRIPTION OF THE PREFERRED EMBODIMENT

The invention was developed using MICROSOFT® Visual Basic 6.0 with XML (Extended Markup Language) and MICROSOFT® SQL server as the backend database. The functionality, screens, documentation, and substance of MICROSOFT® Visual Basic, and SQL® Server are readily available and therefore not repeated here.

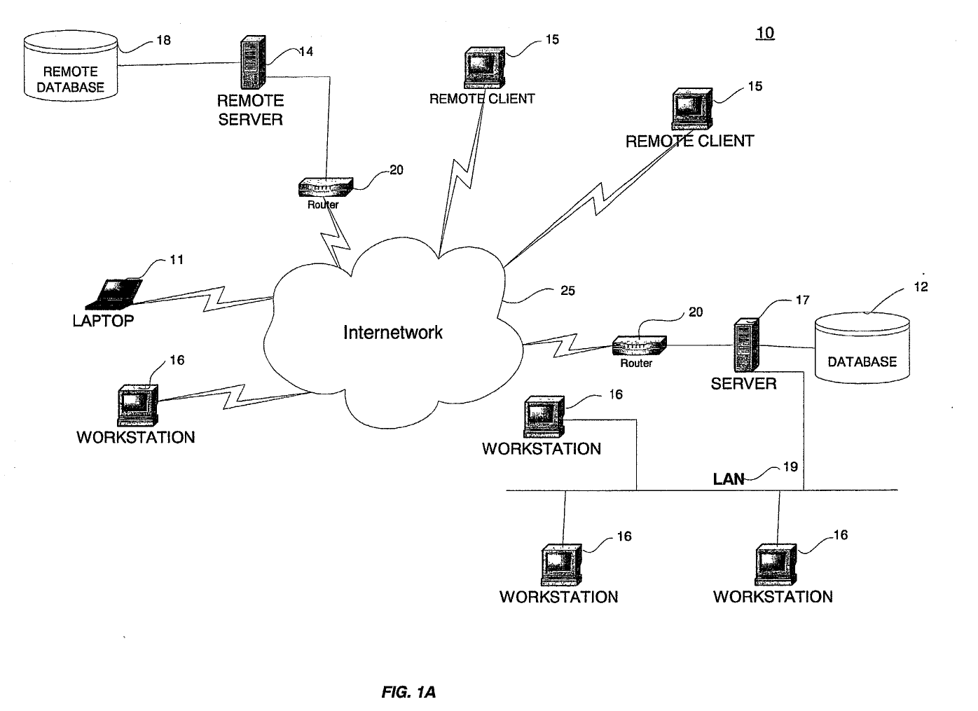

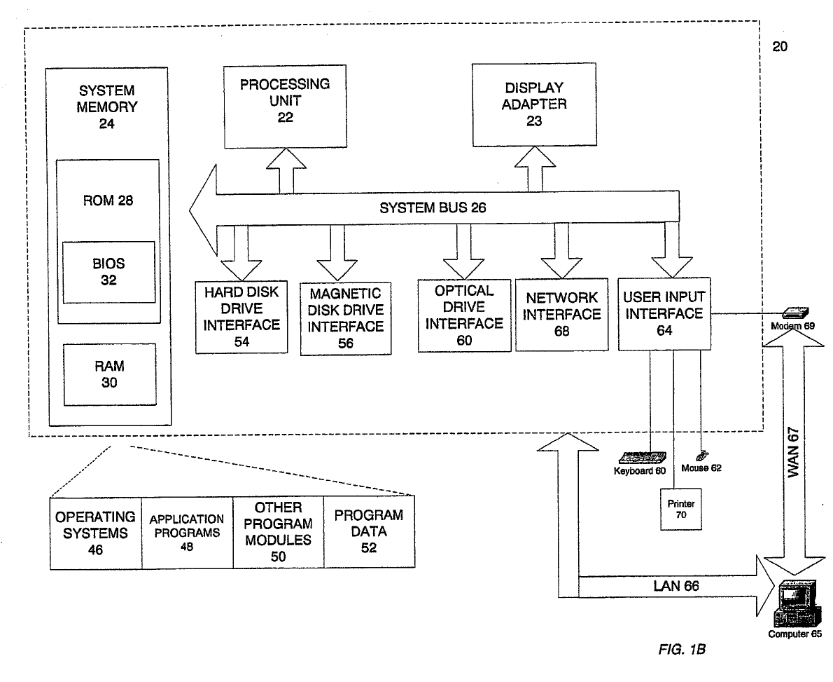

FIG. 1A illustrates a block diagram showing an exemplary system 10 for automation and management of immigration case files of client information retrieved from a remote client server 14 and/or a local client server 17 in accordance with the present invention. Aspects of the present invention are embodied in one or more server computers and other system components accessible through, and utilizing the Internetwork. The term “Internetwork” refers to a collection of networks and routers that use the Transmission Control Protocol/Internet Protocol (“TCP/IP”) to communicate with one another.

In the described embodiment, the routers 20 are special purpose computers used to interface one LAN (Local Area Network) or WAN (Wide Area Network) to another. Communication links within the LAN's may be twisted wire pair, or coaxial cable, while communication links between networks may utilize 56 Kbps analog telephone lines, or other types of high-speed communication links known to those skilled in the art. Furthermore, computers, such as remote client computers 15, workstation 16, or laptop 11, and other related electronic devices can be remotely connected to either the LAN 19 or the WAN via a modem and temporary telephone link, or other network connection.

Communication over the Internetwork typically takes place based upon an information exchange between client computers and server computers. Each client computer and server computer is assigned an Internet Protocol (“IP”) address that uniquely identifies the computer on the Internetwork. The IP addresses of server computers may also map to domain names using a series of name server computers also accessible over the Internetwork.

The individual servers and workstations are general purpose, programmed digital computing devices consisting of a Central Processing Unit, and will be described in more detail below with respect to FIG. 1B.

The server 17 includes a plurality of individual workstations 16 interconnected to the Intranetwork or LAN 19, some of which can include peripheral devices (not shown). The workstations 16 are for use by attorneys, assistants, office staff, data management and programming staff and other consultants and authorized personnel.

The database 12 or 18 consists of a high-capacity storage medium configured to store individual client records and related immigration related data. Examples of suitable mediums utilized for the database are: volatile storage, non-volatile storage, removable storage, fixed storage, random access storage, sequential access storage, permanent storage, and erasable storage.

FIG. 1B illustrates a typical hardware configuration of a computer in accordance with the present invention having a central processing unit 22, such as a conventional microprocessor, and a number of other units interconnected via a system bus 26. The system bus 26 may be any of several types of bus structures including a memory bus or memory controller, a peripheral bus, and a local bus using any of a variety of bus architectures. The computer 20 shown in FIG. 1B also includes a system memory 24 comprised of non-volatile and volatile memory such as Random Access Memory (RAM) 30, Read Only Memory (ROM) 28, and Basic Input/Output System (BIOS) 32. The computer 20 also includes a hard disk drive interface 54 for connecting a Compact Disk drive, a magnetic disk driver interface 56 for connecting a magnetic disk drive, an optical drive interface 60 for connecting a DVD (Digital Versatile Disk (DVD), and a user input interface 64 for connecting peripheral devices such as a keyboard 60, a mouse 62, and a printer 70. The computer 20 has a resident operating system 46 such as Microsoft's WINDOWS 2000®, application programs 48, other program modules 50, and program data 52. While the above computer elements are typical and preferred, many are not essential to this invention. For example, other program modules 50, a magnetic disk drive, a DVD, and other elements could be eliminated from a computer that could still perform the inventive functions.

The computer 20 may operate in a network environment using logical connections to one or more remote computers 65. The remote computer 65 may be a personal computer, a server, a router, a network PC, or other common network nodes. The logical connections include a local area network (LAN) 66 and a wide area network (WAN) 67, but also include other networks. Such network environments are commonplace in office, enterprise wide computer networks, Intranets and the Internet. When used in a LAN network environment, the computer 20 is connected to the LAN 66 through a network interface adapter 68. When used in a WAN network environment, the computer 20 includes a modem 69 or other means for establishing communications over the WAN 68, such as the Internet.

Before proceeding further, the definitions of a few terms are described. As used in the description of this invention the term, “software component” is defined as one or more computer programs or modules related and integrated for performing a specific function. The term, “triggers” refers to special user-defined actions usually in the form of stored procedures that are automatically invoked by the database manager based on data-related events. A “rule” is a special type of trigger that is used to perform simple checks on data. Both “triggers” and “rules” are attached to specific operations on specific tables. In other words, an event tells the database server that something happened to the database; a trigger or rule is an event handler procedure that takes proper action in response to an event. The term, “ADO” (ActiveX Data Object) is an object model consisting of (1) connection objects that represent a connection to a data source, (2) command objects that represent a query (or command) to be executed on the data source, and (3) recordset object that represents the results of the query. The term, “foreign national” refers to a client of the law firm or any other individual seeking immigration approval, a work visa or otherwise having a case to be managed by the present invention. By “status documents”, it is meant any document that evidences status and has an expiration date such as visas, passports, I94's, EAD's, Advance Paroles, non-immigrant status NIV, AOS, LPR, and USC. By “project,” it is meant any distinct unit of work most often corresponding to a petition. By “article,” it is meant one of the six articles conceptualized in accordance with the present invention—person, organization, project, site, document and page. By “organization,” it is meant both companies and government agencies.

When project tracking, scheduling tools of daily tasks, and producing reminder lists, the electronic case manager gathers the data from the relational database. Because the program generates output dynamically as desired by the user, the output will reflect the current state of the relational database in the electronic case manager.

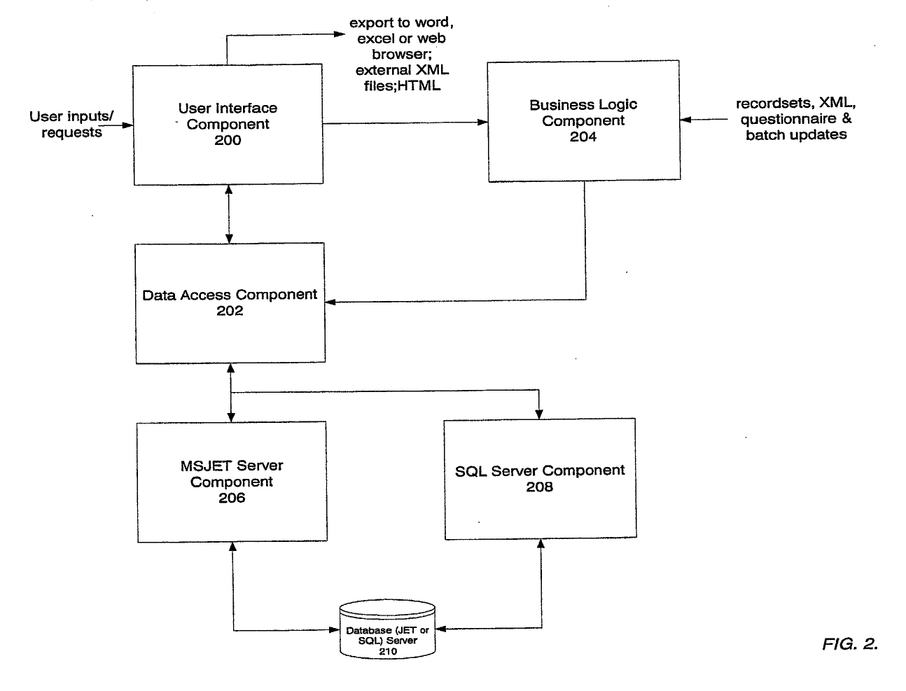

Referring now to FIG. 2, several presently preferred embodiments of the present invention will be described. According to one actual embodiment of the present invention, the software components of the server in FIG. 1 comprise of a user interface component 200, a data access component 202, a business logic component 204, an SQL Server component 208, and a database server 210 are provided. These components are executed in a distributed computing environment although a single server or a cluster of servers could also perform the functionality of these components.

For each client retrieving remote immigration related data, the server 14 and 17 periodically receives recordsets, batch updates, XML and questionnaires which are forwarded to the business logic component 204 for processing. The data access component 202 organizes the individual client immigration data records stored in the database and provides the reports and facilities for efficient storage and access of the immigration related data maintained in the records.

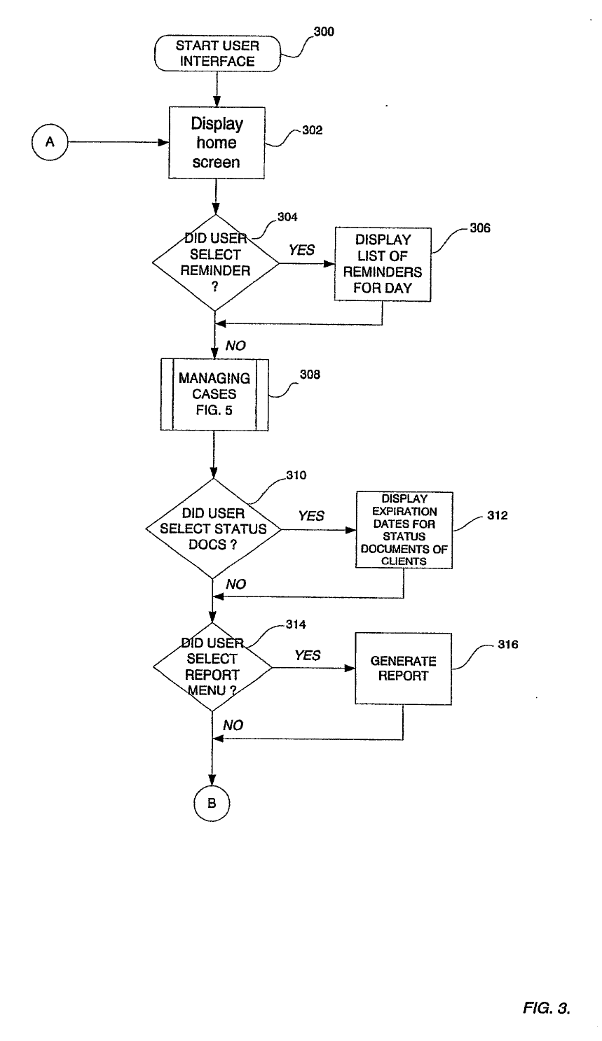

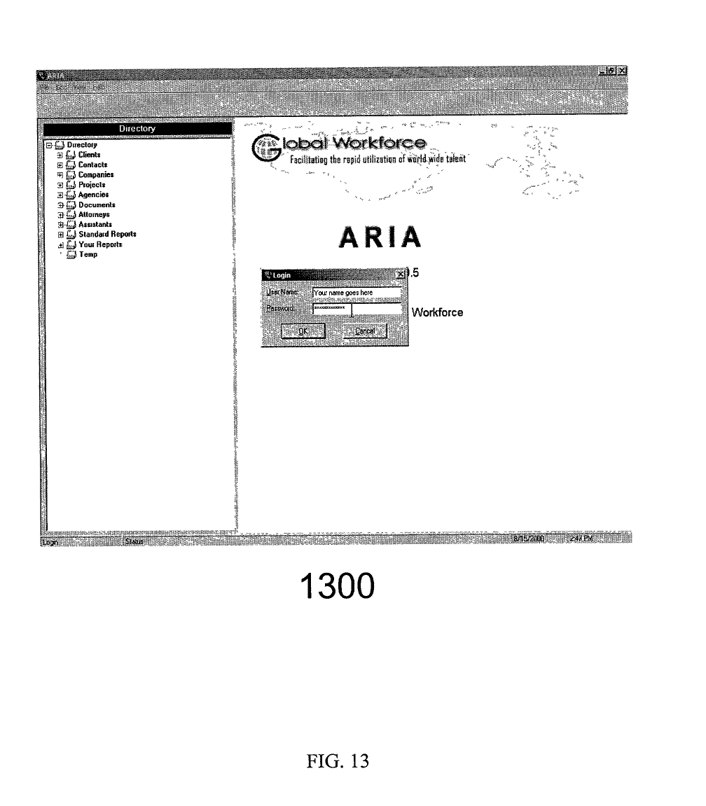

The server 14 and 17, performs the functionality of the user interface 200, business logic 204, data access 202 and the SQL component 208. Any type of database organization could be utilized, including a flat file system, hierarchical database, relational database or distributed database, such as provided by database vendors, such as SQL or MSJET. The user interface component 200 is an MDI (multiple document interface) created in VISUAL BASIC. It provides a user with a visual display of the articles within the database 210. The directory is a tree view control, located on the left side of the display screen. (See FIGS. 13 through 17.) The user interface component primarily interacts with the user from the directory tree view control by accepting requests and taking the appropriate action in response to the user requests. Additional aspects of the user interface component 200 are described below with respect to FIGS. 3, 4, 5, 6, and 7.

The data access component 202 consists of classes or objects mostly of SQL statements to create connections to the underlying databases 210 and database table. The data access component 202 also: comprises centralized routines for getting recordsets that are the results of a query; handles the routines specific to the Article types; comprises SQL stored procedures for general reports that appear in the Browse screen; comprises SQL stored procedures to generate the tree view Directory; and comprises software procedures specific to creating links that are the relationships between the Articles.

The business logic component 204 comprises software classes or objects to control the logic for processing immigration information. Generally, the business logic component 204 retrieves the disconnected recordsets through batch updates and stores the data in properties within the class objects. The business logic component 204 comprises software objects for defining each of the Articles (e.g., person, project, organization, site, document, and page) by interacting with the data access component 202. When a new article is created, the new article object is assigned a unique DID (directory identification) number and is stored in the directory table within the database 210. In addition to the Article class object, the business logic component 204 comprises other class objects for Directory, Browse, and HTML. The Directory class object comprises software methods pertaining to the directory tree view. The Browse class object comprises software methods in conjunction with the Browse screen and the HTML class object comprises of methods for generating the HTML reports.

### Overview of the Tables

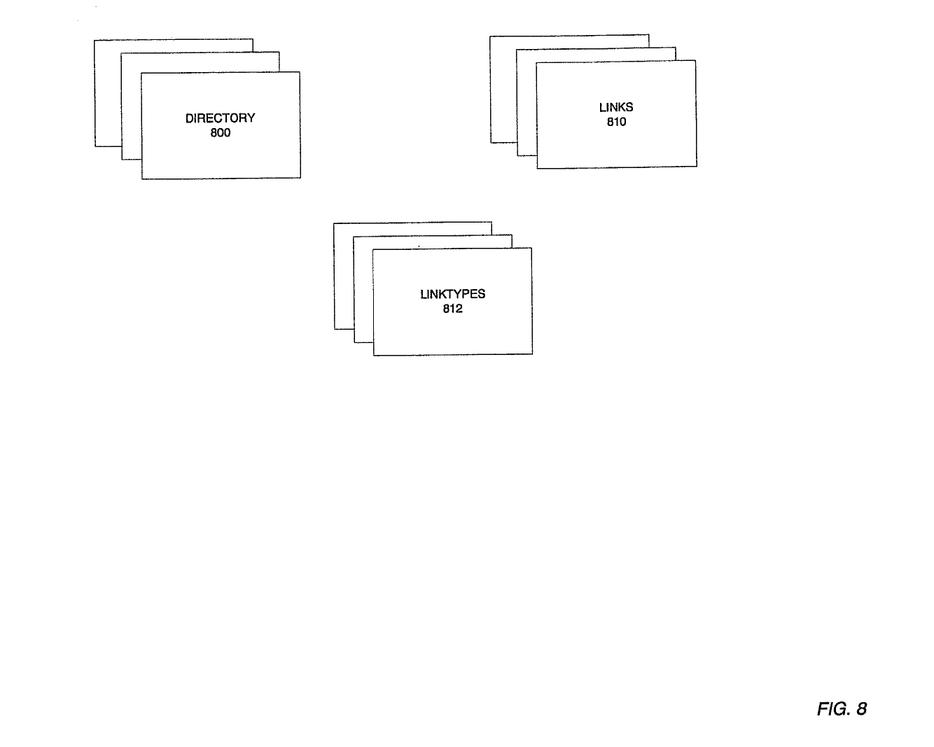

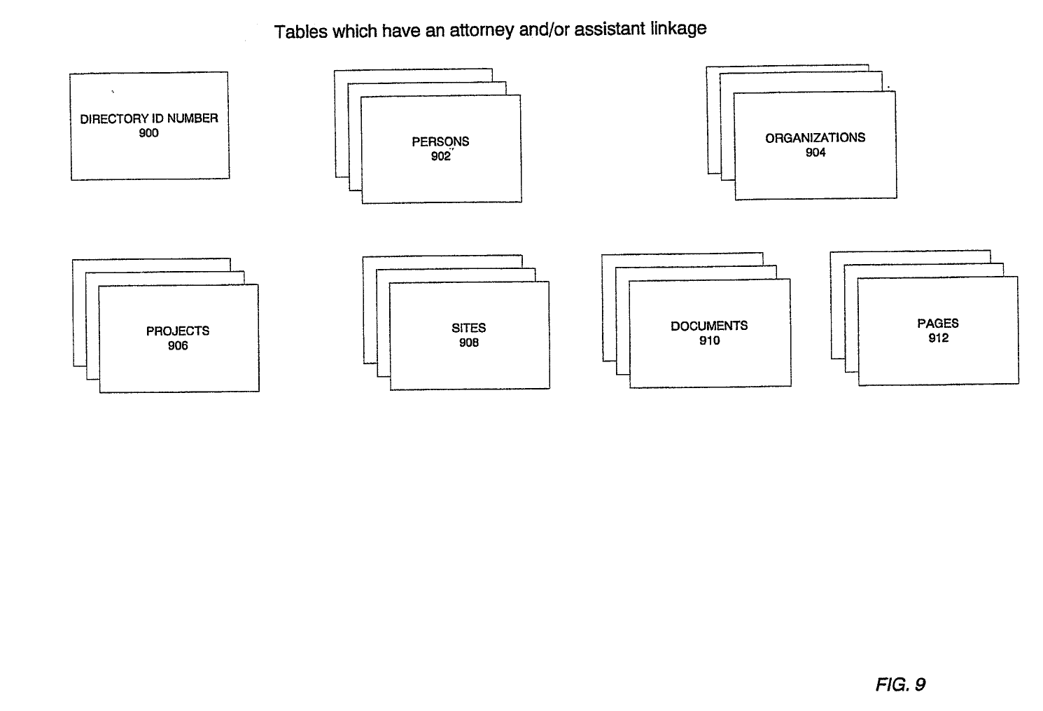

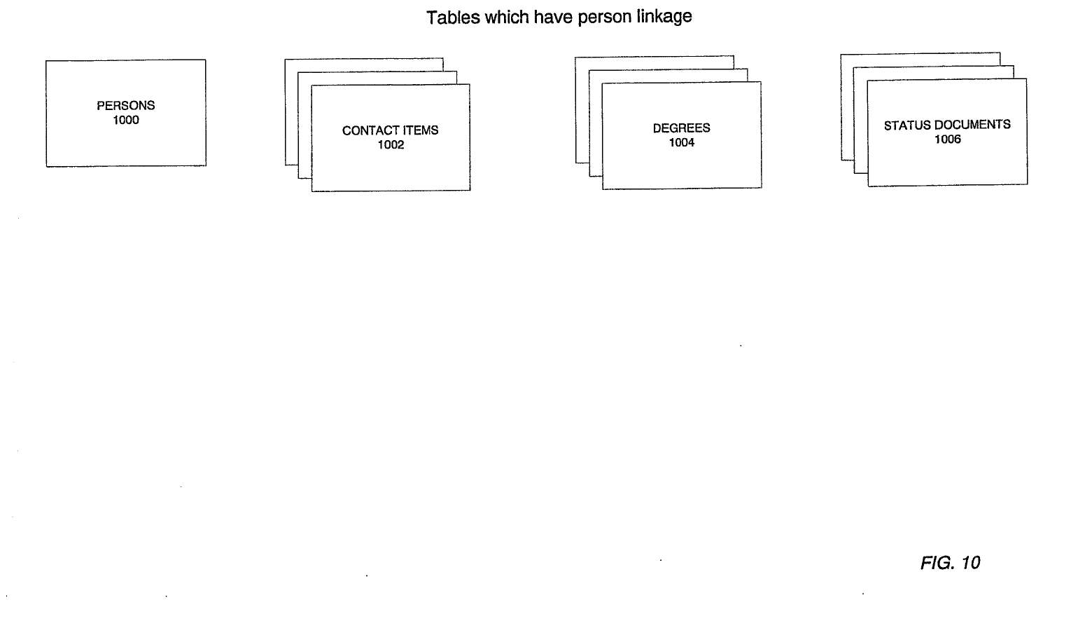

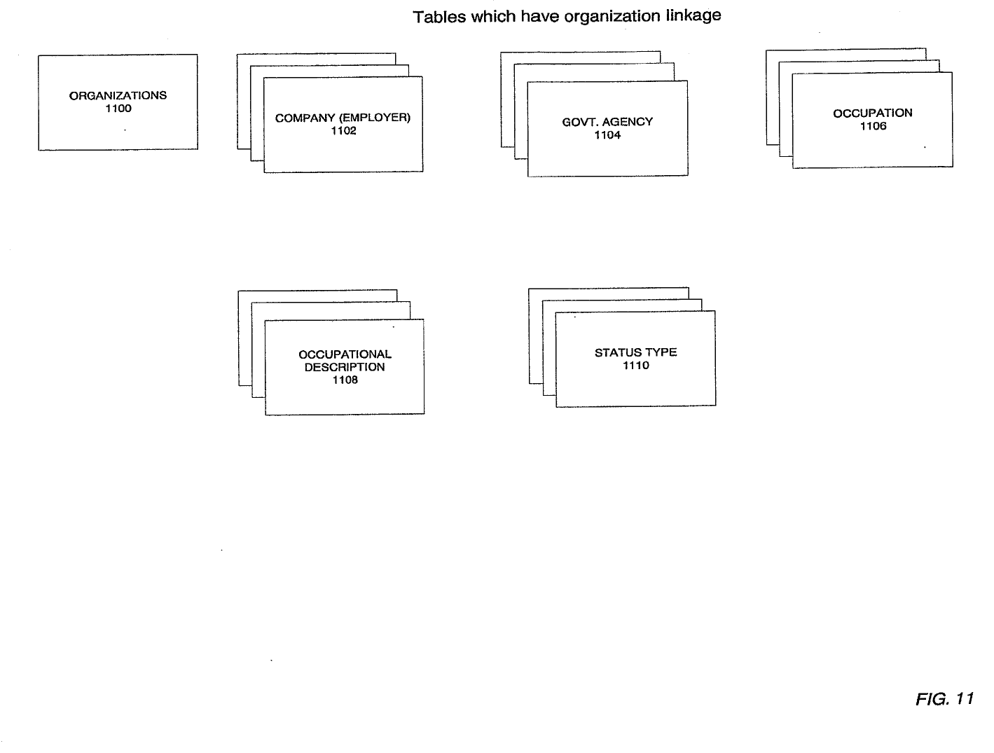

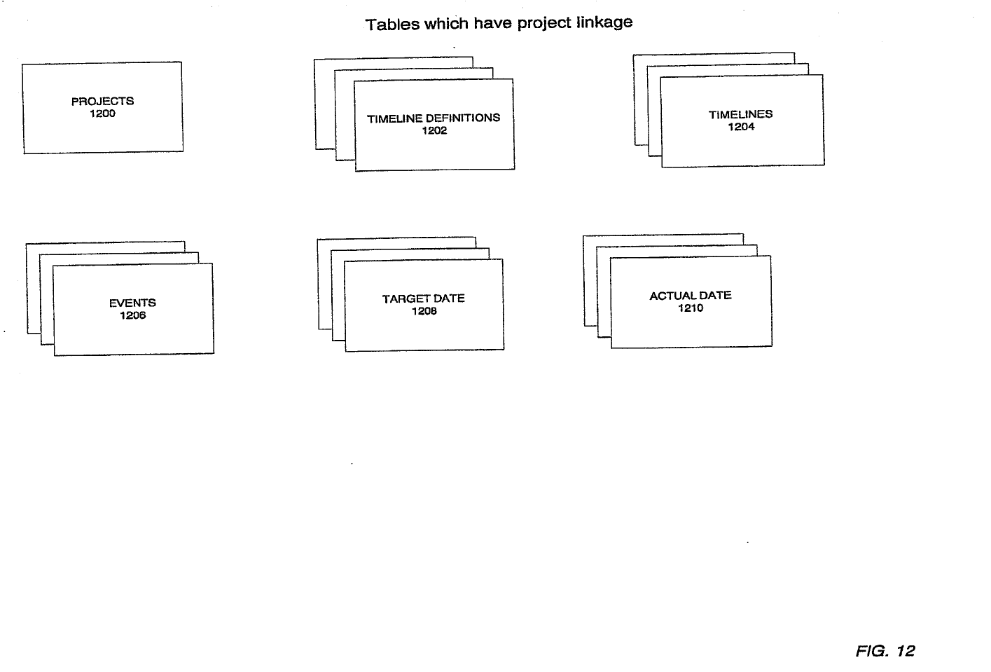

The block diagrams of FIGS. 8-12 collectively show an electronic case manager relational database in accordance with the present invention. The database includes a directory table 800 of stored articles (person, organization, project, site, document and page), links 810, and link types 812 as shown in FIG. 8. When a new article is created, the new article is assigned a unique directory identification number and stored in the table, directory 800. The tables of Table I (below) are shown in FIG. 9. Table I lists the tables that store records specific to the six articles of the directory table. Preferably, data entry screens or “wizards” (a step-by-step process used to guide a user to add articles or edit data) are used for entering data into the data structure of the present invention. The following tables include columns identifying the data structure of the present invention, a description of the data stored in the table, and the corresponding reference number in FIGS. 9-12, 15, 16, 19, 20, & 21.

TABLE I

| Table name | Description | Reference |
|---|---|---|
| Persons | Information about foreign | 910 |
| | nationals, managers, attorneys, | |
| | assistants, and all other persons | |
| Organizations | Information about companies, | 912 |
| | agencies, and all other | |
| | organizations | |
| Projects | Information about projects | 914 |
| Sites | | 916 |
| Documents | | 918 |
| Pages | Information about custom | 920 |
| | defined user fields | |

### Information About Each Table

Before describing the individual fields of each table, several fields that appear in the tables are described, including reference number, attorney name, and assistant name fields. The reference number field in various tables will be the file number corresponding to the law firm's internal file number for the case. However, the file number need only be unique for each case, and could be generated by the database manager. Likewise, the present invention need not be used by law firms, but may also be used (and therefore reference numbers generated by) components, individuals, or other entities.

The present invention recognizes two preferred types of registered users—attorneys and assistants. Each person, organization, and project includes an assigned primary or collaborating attorney name and assistant name. This permits linkages between person, organization, and projects that have one primary attorney and one primary assistant who have lead responsibility on a case. In accordance with the present invention, primary attorneys and assistants appear on external reports to clients and have lead responsibility for each case.

Each person, organization and project can have as many collaborating attorneys and assistants as required to assign teams of people working on a case.

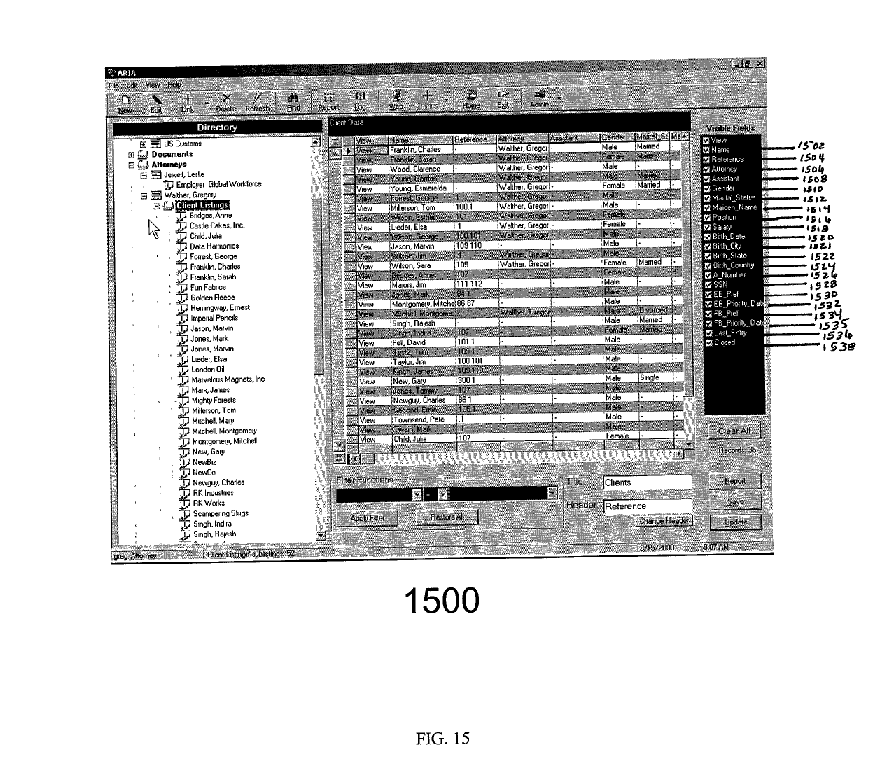

Turning now to the remaining tables, the fields in the person table 910 are shown in Table II. These fields and additional fields are shown in FIG. 15. The person table is linked to the directory table. Preferably, this linkage is arranged by including a unique directory identification number field in the person table.

TABLE II
Persons Table Structure

| Field Name | Description | Reference |
|---|---|---|
| name | Petitioner name | 1502 |
| reference number | Unique directory ID number | 1504 |
| attorney | Attorney name | 1506 |
| assistant | Assistant name | 1508 |
| gender | Sex | 1510 |
| marital status | Marital status | 1512 |
| maiden name | Maiden name | 1514 |
| position | Job occupation | 1516 |
| salary | Salary | 1518 |
| birth_date | Mm/dd/yy | 1520 |
| birth_city | Birth city | 1521 |
| birth_state | Birth state | 1522 |
| birth_country | Birth country | 1524 |
| a_number | Alien registration number | 1526 |
| Ssn | Social security number | 1528 |
| eb_pref | | 1530 |
| fb_priority_date | | 1532 |
| fb_pref | | 1534 |
| fb_priority_date | | 1535 |
| last_entry | | 1536 |
| closed | | 1538 |

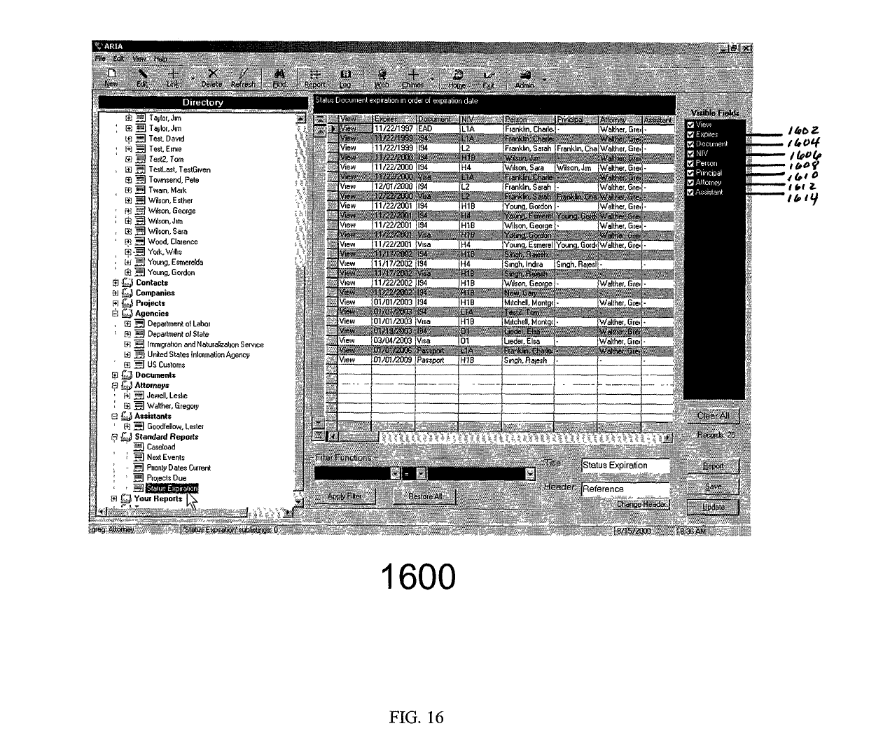

The fields in the status document table 910 are shown in Table III. These fields and additional fields are shown in FIG. 16.

TABLE III
Status Document Table Structure

| Field Name | Description | Reference |
|---|---|---|
| Expiration date | Final expiration date | 1602 |
| Status document | Type of status document | 1604 |
| NIV | NIV status | 1606 |
| Person | Petitioner name | 1608 |
| Principal | Principal name | 1610 |
| Attorney | Responsible attorney name | 1612 |
| Assistant | Assistant name | 1614 |

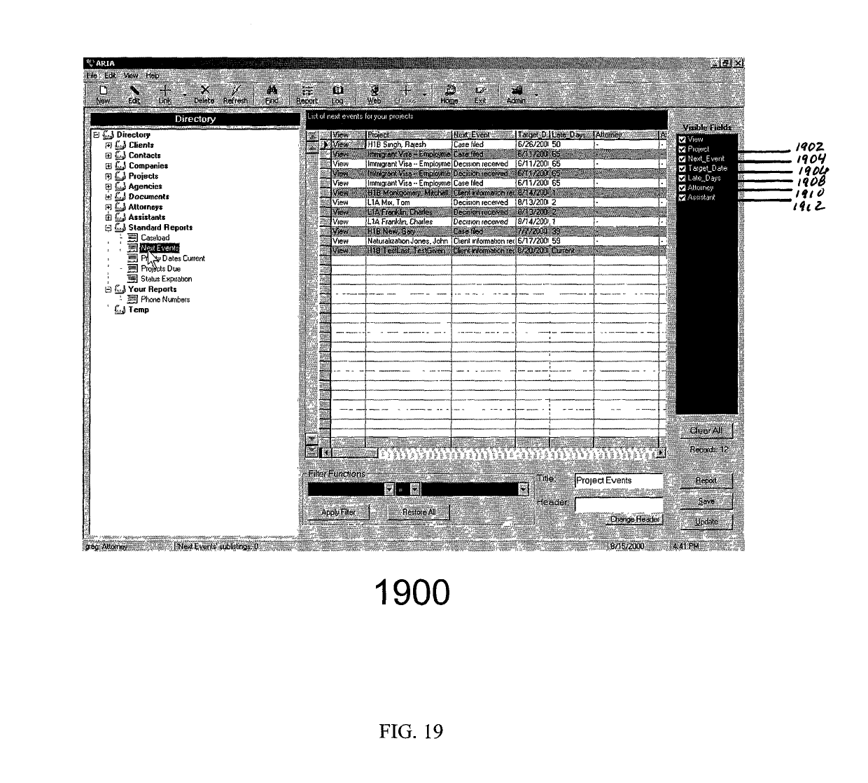

The fields in the project table 906 are shown in Table IV. These fields and additional fields are shown in FIG. 19. The project table is linked to attorney and assistant. Preferably, this linkage is arranged by including an attorney and assistant field name in the project table.

TABLE IV
Project Table Structure

| Field Name | Description | Reference |
|---|---|---|
| Project | Project name | 1902 |
| Next_event | Type of next event | 1904 |
| Target date | Target date | 1906 |
| Late days | Number of days project is late | 1908 |
| Attorney | Attorney name | 1910 |
| Assistant | Assistant name | 1912 |

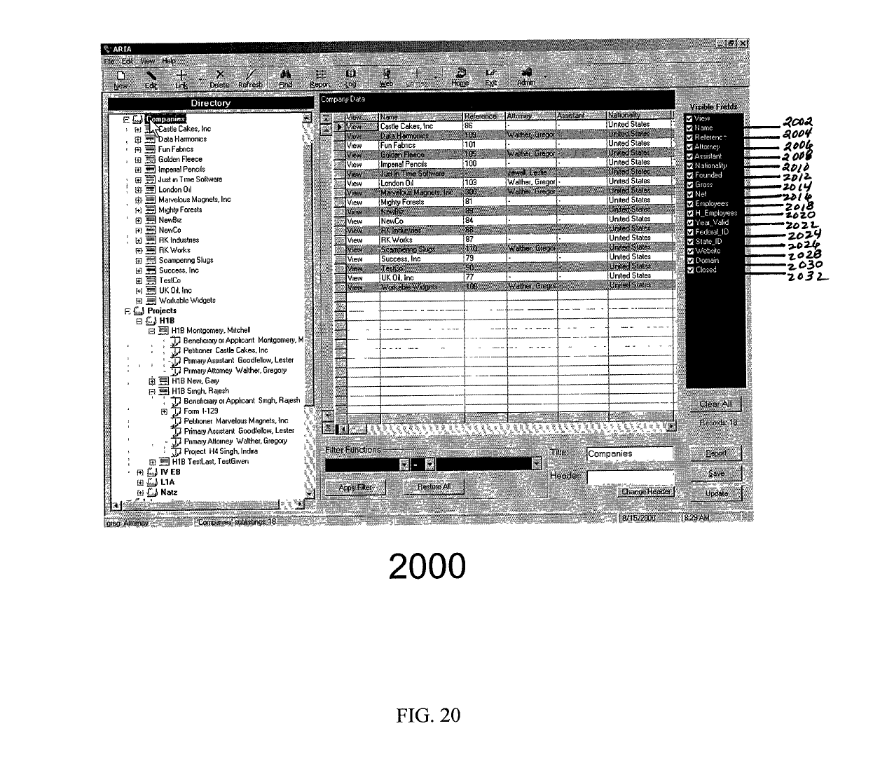

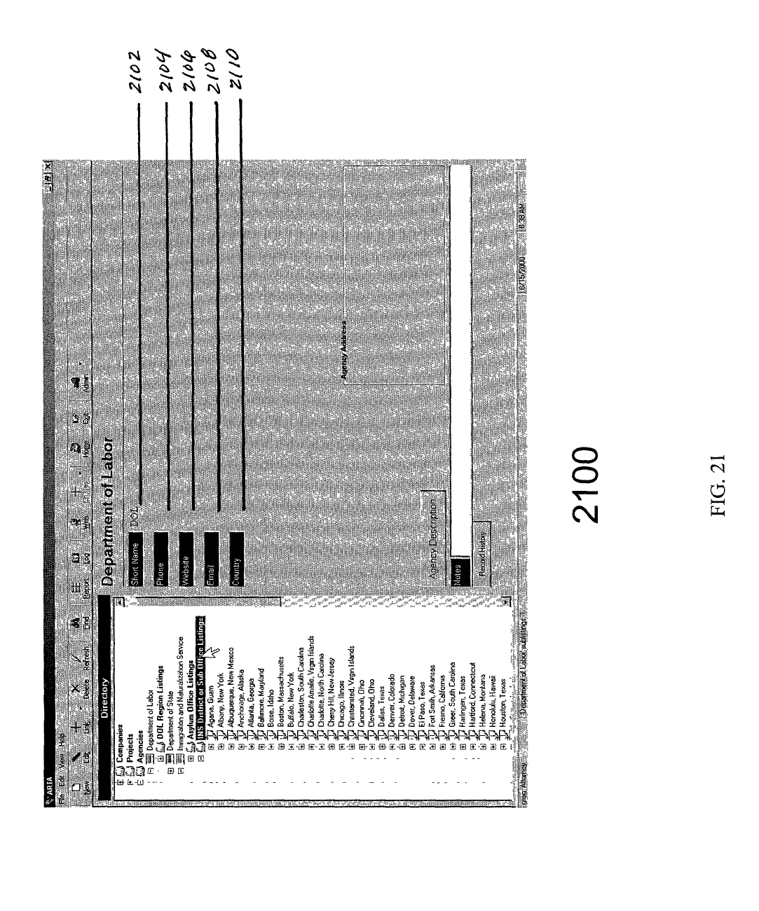

The organization table 904 includes both company, agency, law firm, or other organization table structures. The fields in the company table are shown in Table V. These and additional fields are shown in FIGS. 20 and 21. This linkage is arranged by including a unique directory identification field in the organization table.

TABLE V
Company Table Structure

| Field Name | Description | Reference |
|---|---|---|
| Name | Company name | 2002 |
| Reference number | Unique directory ID number | 2004 |
| Attorney | Attorney name | 2006 |
| Assistant | Assistant name | 2008 |
| Nationality | Company origin | 2010 |
| Founded | Date company established | 2012 |
| Gross | Company gross | 2014 |
| Net | Company net | 2016 |
| Employees | Number of employees | 2018 |
| H_employees | | 2020 |
| Year_valid | | 2022 |
| Fed_Id | Federal registration ID | 2024 |
| State_Id | State registration ID | 2026 |
| Website | Company website address | 2028 |
| Domain | Company domain type | 2030 |
| Closed | | 2032 |

TABLE VI
Agency Table Structure

| Field Name | Description | Reference |
|---|---|---|
| Short name | Name of agency | 2102 |
| Phone | Contact number of agency | 2104 |
| Website | Official agency website | 2106 |
| Email | Email address | 2108 |
| Country | Country agency is located | 2110 |

### Table Linkages

Tables preferably are linked by unique directory identification number (DID): persons, organizations, projects, sites, documents and pages. Depending on the desired relationships each table is linked by one or more DID.

The tables that are preferably linked by attorney and assistant include the persons, organizations, and projects tables.

The tables that are preferably linked by person or client include the status documents (e.g. passport, VISAS, I-94's) and contact information tables.

The table that is preferably linked by organization including companies and agencies is the employees table.

While the above linkages are preferred, fewer or additional linkages may also be used, consistent with this invention.

### Database Manager

In conjunction with the data structure described above, the electronic case manager for the automation of immigration case files includes a user interface software component having instructions and arranged for managing the data structure to allow users to generate custom reports of pending actions, status, expirations, and priority dates and to publish them in a number of formats, including Word, Excel and HTML. Additionally, the invention allows users a scheduling tool to provide daily task lists and reminders lists to help manage time effectively including the ability to track and combine important dates with dates on other software such as Microsoft Outlook or handheld calendar devices (e.g. Palm Pilots, Windows CE, etc.) The electronic case manager allows users the ability to export reports to create external XML or HTML files for the Web.

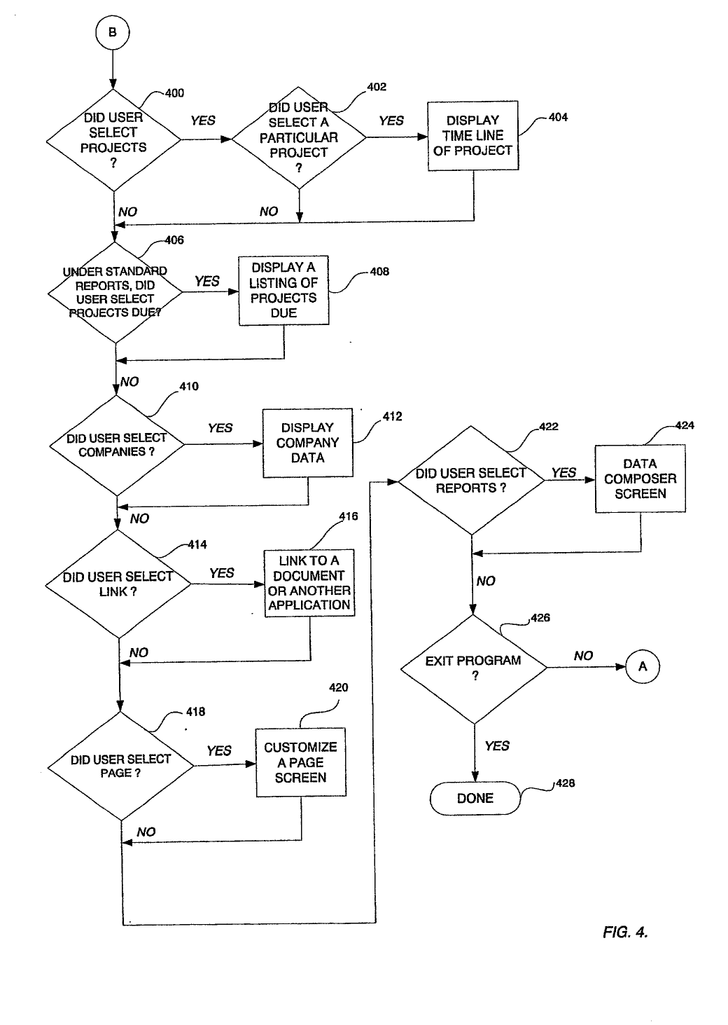

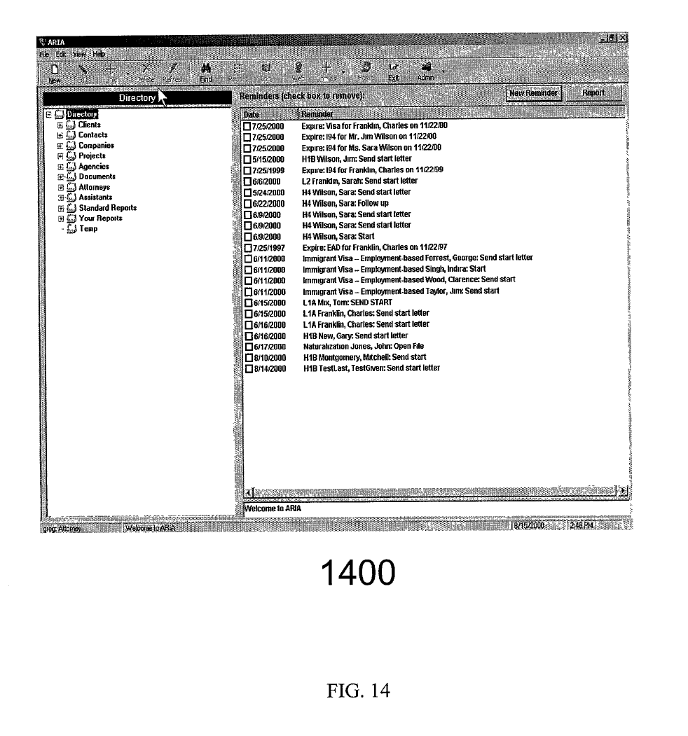

The operation of the user interface software component is further described with reference to FIG. 3, which provides a flowchart setting forth the logic of the user interface component in accordance with the present invention. Processing begins at block 300 (or a recursive call made from FIG. 4, block 424) and control immediately passes to block 302, where a Home Screen is displayed. FIG. 13 is a screen shot of the Home Screen. On the left side of the Home Screen is a directory, which is a tree-view panel that the user uses to navigate the database manager program. On top of the screen are the menus and the toolbar, which provide access to special functions such as reports and “wizards.” These functions are used for adding new articles to the database tables. After block 302, processing continues to a decision block 304 where a determination is made as to whether the user selects Reminder from the Home Screen. If at block 302 it is determined that the user selects Reminder, then at block 306, a list of reminders for the day is displayed. FIG. 14 is a screen shot of Reminders for the day. Users can assign reminders to themselves or to other registered users. The reminders list displays project actions to be completed. Additionally, the list displays warnings about upcoming status document expirations.

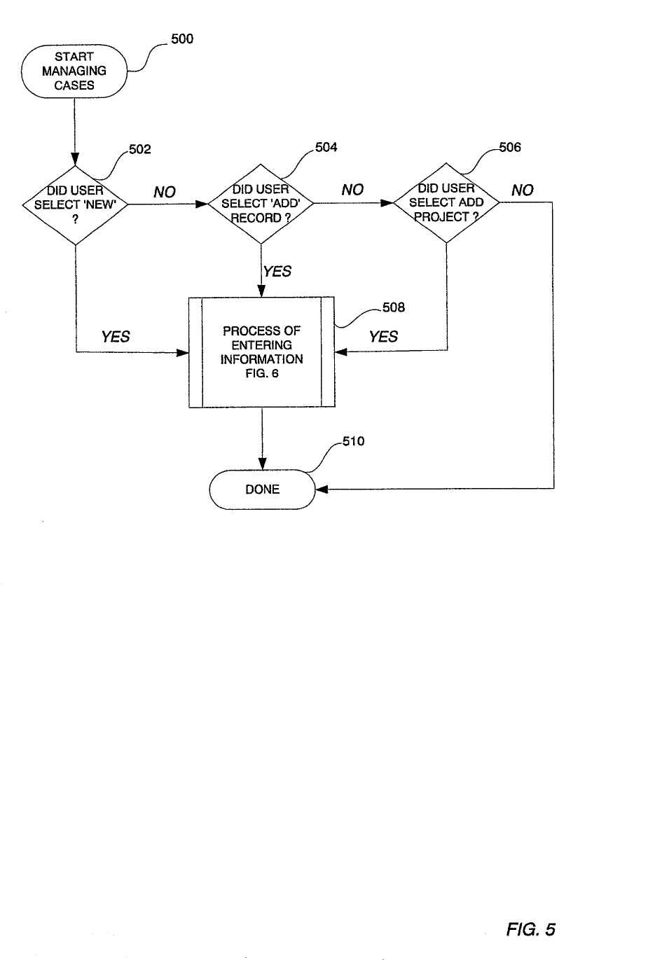

If at block 304 it is determined a user did not select Reminder, processing continues to block 308, to managing cases. Managing cases will be described in more detail below with reference to FIGS. 5 and 15. From block 308, processing continues to decision block 310 where a determination is made as to whether the user selects Status Documents from the Home Screen. If at block 308 it is determined the user selects Status Documents from the Home Screen, processing continues to block 312 where a display of expiration dates for status documents of all the registered user's clients is listed. The Status Document Expiration screen is accessible from the toolbar of the Home Screen. Alternatively, a user may filter a particular type of status document using the list to the right. Selecting a record brings up more detailed information on the bottom of the screen, including pending projects of the status holder. By selecting Report, a user is able to generate a report of the status expiration dates. The report generated will reflect any sorting or filtering performed. Alternatively, a user can also select Browse to send the data to the Data Browse screen. Refer to FIG. 16, a screen shot illustrating the Status Document Expiration display.

If at block 310 the user did not select Status Documents, processing continues to decision block 314 to determine if a user selects Report Menu. If at block 314 it is determined the user selects Report Menu, processing continues to block 316 to generate a report. However, if at block 314 it is determined a user did not select Report Menu, then processing continues to FIG. 4, decision block 400 to determine if a user selects Projects. If at block 400 it is determined a user selects Projects, then processing continues to decision block 402 where another determination is made as to whether a user selects to display the timeline of a particular project. If it is determined a user selects to display the project timeline, processing continues to block 404 to display the project timeline. Projects are a distinct unit of work defined in the context of immigration and most often correspond to a petition. Once a project is defined, it is broken down into a series of events typically including the following five events:

| | |
|---|---|
| Open | refers to when a project is first opened. |
| Prep | refers to when all materials are in hand |
| | to proceed with preparation for filing. |
| File | refers when the project is filed. |
| Dec | refers to when a decision is received. |
| Done | refers to when you close the case. |

Thus, by structuring projects with these five events, the present invention allows a user to quickly create structured reports for respective clients. It also allows the calculation of meaningful statistics such as average processing time for each stage of various projects. In addition to, or instead of, theses five events, in accordance with the present invention, users may define custom events.

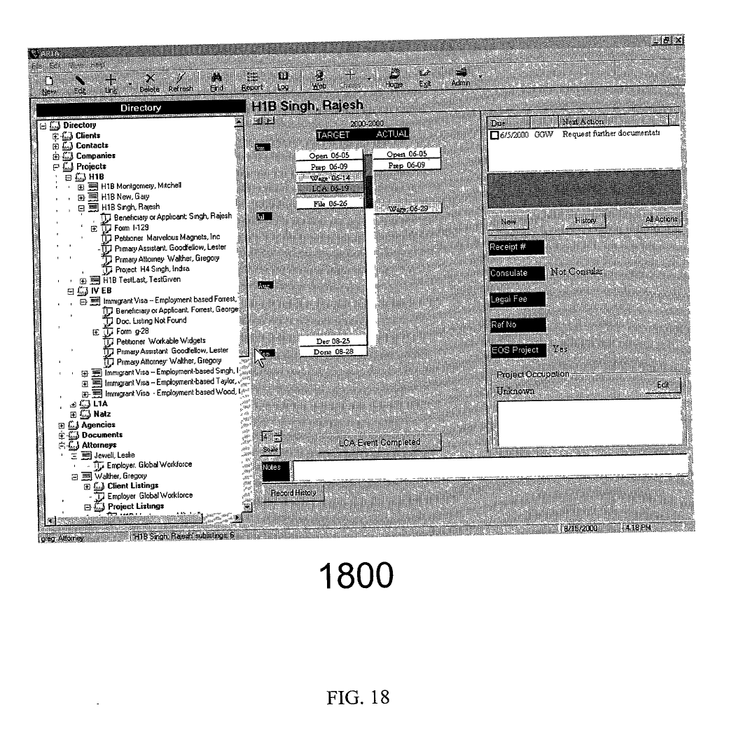

Each project is also associated with a timeline. A timeline breaks a project down into a series of key events. A visual representation of the timeline on the projects screen allows a user to quickly determine a project's status. FIG. 18 is a screen shot illustrating the timeline 1802 of a particular project. Red on the timeline 1802 indicates a lag between the target date and the actual date. As a result a user always has visual indication of the overall progress on a case. As opposed to traditional to-do lists where a user modifies target dates, the present invention alerts a user as to when a case is late.

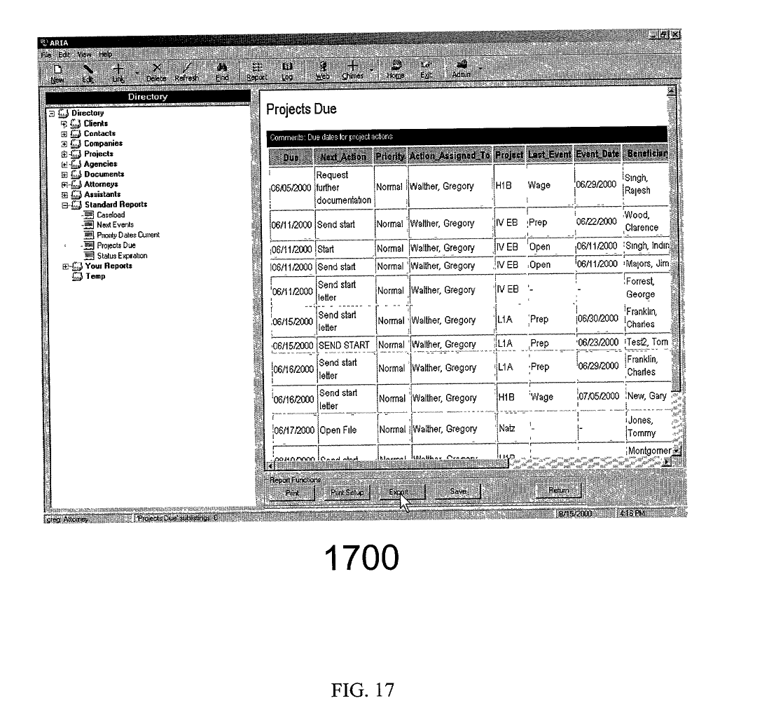

If at block 400 it is determined a user did not select Projects, then processing continues to decision block 406 to determine whether the user selects Projects Due under Standard Reports. If it is determined a user selects Projects Due, processing continues to block 408 to display a listing of projects due. Under this selection, a grid is displayed with all of the next actions for a particular project in order of due dates. FIG. 17 is a screen shot illustrating Projects Due. Alternatively, a user may choose to see all of the next actions or only the ones past due. The next actions are initially entered on the Project screen. FIG. 19 is a screen shot illustrating Next Events of Projects Due.

If at block 406 it is determined a user did not select Projects Due, processing continues to decision block 410 to determine whether a user selects Companies. If at block 410 it is determined a user selects Companies, processing continues to block 412 to display company data. The company data is a stored description for each company which can then be inserted into employer letters, etc. In addition to companies, the present invention tracks agencies and agency offices, allowing a user to maintain information regarding government contacts on a firm-wide basis. FIGS. 20 and 21 are screen shots illustrating the company data and agency data display screens.

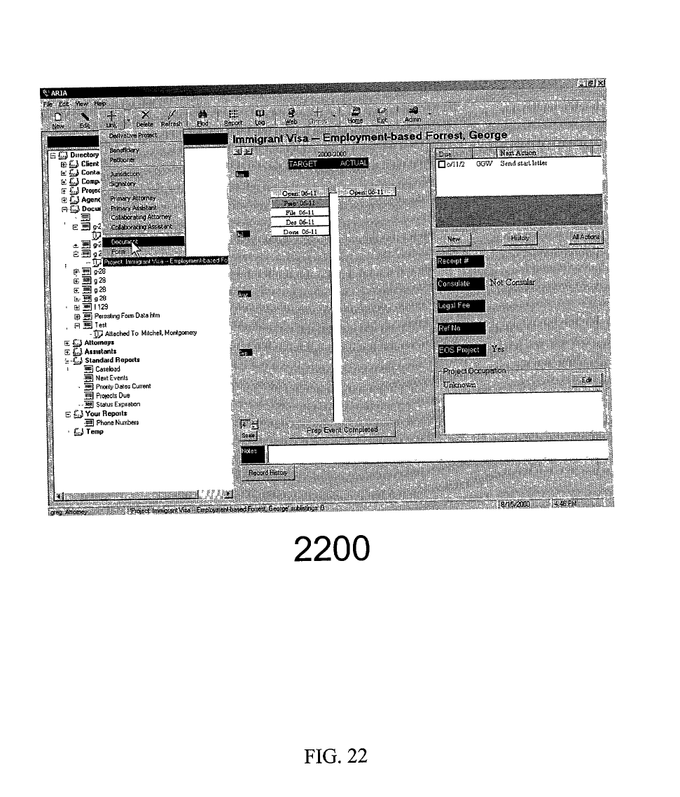

If at decision block 410 it is determined a user did not select Companies, processing continues to decision block 414 to determine whether a user selects Link. If at decision block 414 it is determined a user selects Link, a user is able to add a document to an article by using the Link control feature. This feature allows a user to link a document located on the company network the Internet; link a document produced in another program (e.g. MS Word); open the document directly from the present invention to view or modify; or link a single document for multiple clients, or companies. FIG. 22 is a screen shot illustrating the Link feature.

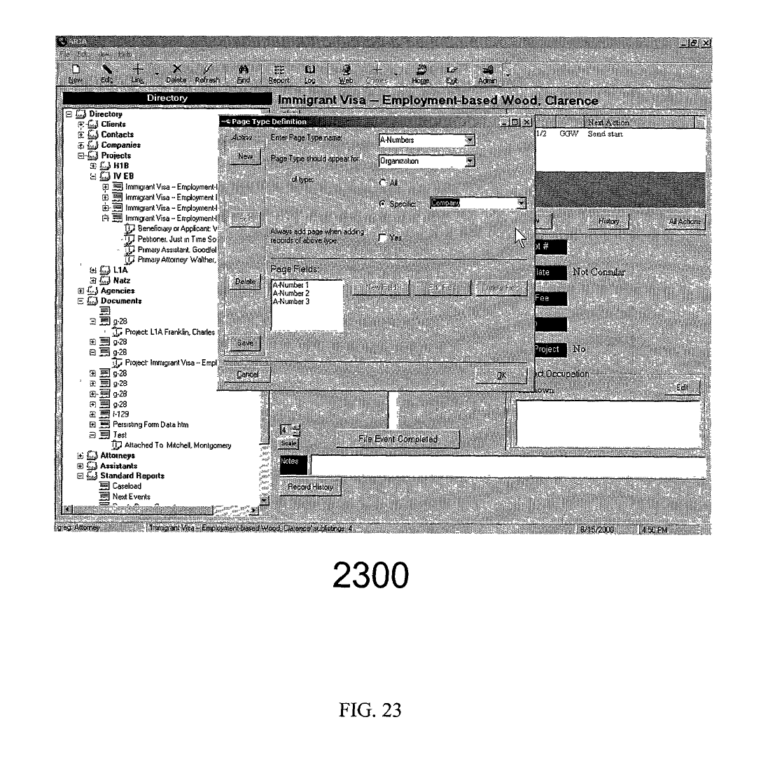

If at block 414 it is determined a user did not select Link, processing continues to decision block 416 to determine whether a user selects Page, to create a customized page of user-defined fields. If at block 416 it is determined a user selects Page, then processing continues to block 418 to customize a page screen. FIG. 23 is a screen shot illustrating creating a custom page of user-defined fields. In accordance with the present invention, the Page feature is used to create as many page types as required and then define the fields to go on the page. If at block 416 it is determined a user did not select Page, processing continues to decision block 420 to determine if a user selects Reports. If at decision block 420 it is determined a user selects Reports, processing continues to block 422 to Data Composer screen. The data composer screen is a tool that allows a user to filter, sort, and rearrange information. Reports are then generated based upon the information from the database. In selecting the database information that will serve as the basis of the report, a user may choose from the following database tables:

All individual Clients
All Principals
All Companies
All Projects (including timeline events)
All Contacts
All Agencies
All Attorneys
All Assistants

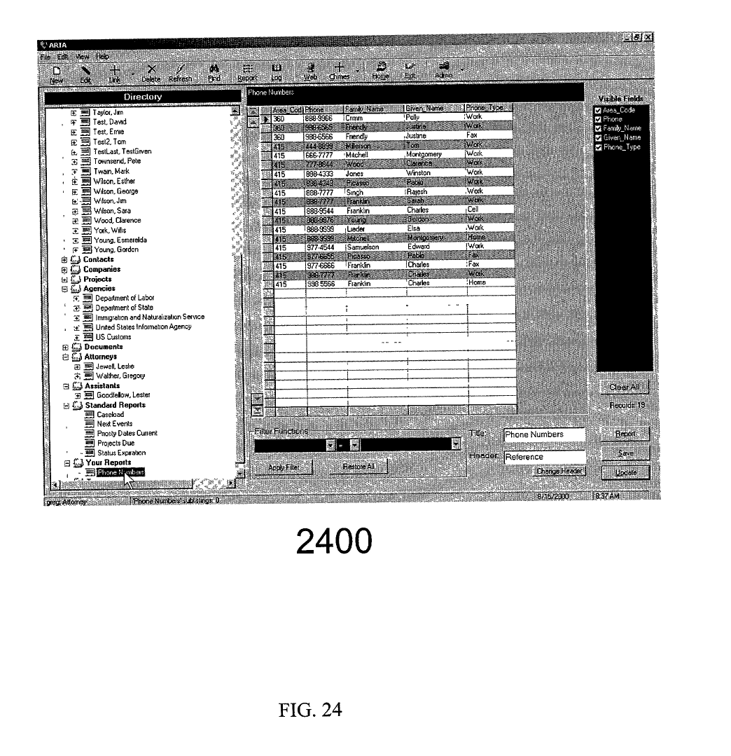

In customizing the reports, once the data is loaded into the Data Composer, a user can apply multiple filters to the data. The filters tell the database manager that only a subset of information is for viewing. The data can be rearranged in the order in which the line items appear relative to a specific column (e.g. if a user desires to sort the records by date). FIG. 24 is a screen shot of rearranging the order in which items appear by applying filters to a subset of data. Aside from printing and saving the reports created, the present invention allows a user to put the report into another format, e.g. Excel spreadsheet, HTML, or a Word document. Other reports include a Caseload Analysis report screen to display the caseload by project type, a count of project events by month, and the average turnaround time between two major or key events. Additional reports include Next Events Report, Priority Dates Current Report, Projects Due Report, Status Expiration Report, Individual Client Report, and Count of Projects Events per month report.

If at decision block 422, it is determined a user did not select Reports, processing continues to decision block 426 to determine if a user selects to exits the user interface component of the database manager program. If at block 426 it is determined a user selects to exit the program processing continues to block 428 where it ends. However, if at block 426 it is determined a user does not exit the program, processing returns to FIG. 3, block 302 to display Home Screen and processing begins again.

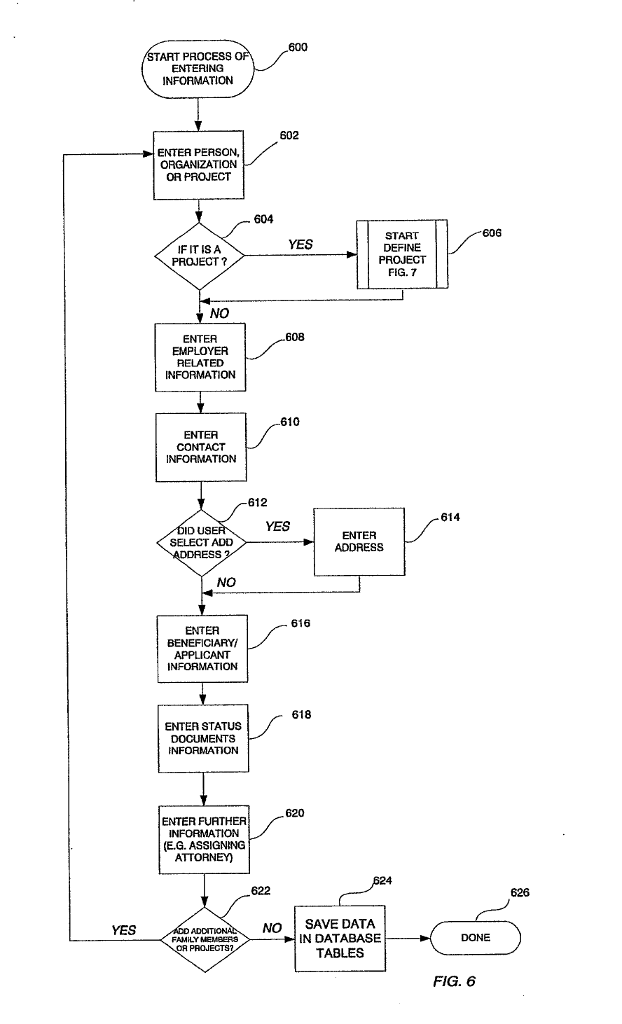

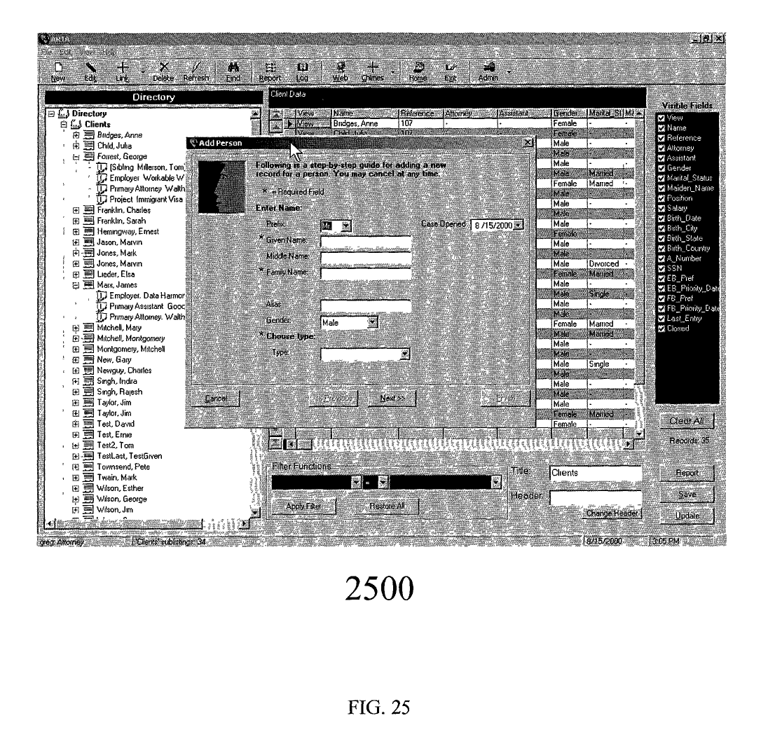

Turning now to FIG. 5, a flowchart setting forth the detailed logic of managing cases of the user interface component in accordance with the present invention will be described. Processing begins at block 500 to start adding new articles—person, organization or project. Typically a user is taken step by step through a process of entering information. When possible, menus and defaults are provided to make the add process as easy as possible. FIGS. 25-31 are screen shots illustrating the step-by-step guide for entering information for person, employer-related, contact, beneficiary/applicant, status, document, primary attorney and additional family members. Control immediately passes to decision block 502, where a determination is made as to whether a user selects “New.” To add a new individual client, a user selects the “New” button on the toolbar, where a user has a choice to add either a new person, organization, or project. If at block 502, it is determined a user selects “New,” processing continues to process of entering information. The process of entering information related to managing cases will be described in more detail with reference to FIG. 6 below.

If at block 502, it is determined a user did not select “New” to create a freestanding project, a new person, or a new organization, processing continues to another decision block 504. There a determination is made as to whether a user selects “Add” to add a record that is related to an existing record. This is more convenient as the database manager program can enter default information based on a primary record. If at block 504, it is determined a user did select “Add” to add a record to an existing record, processing continues to the process of entering information.

If at block 504, it is determined a user did not select “Add”, processing continues to another decision block 506 where a determination is made as to whether a user selects “Add” to add a related project. If at block 506, it is determined a user did select “Add” to add a related project, processing continues to process of entering information.

If at block 506, it is determined a user did not “Add” a related project or existing record, processing continues to block 510 where it ends.

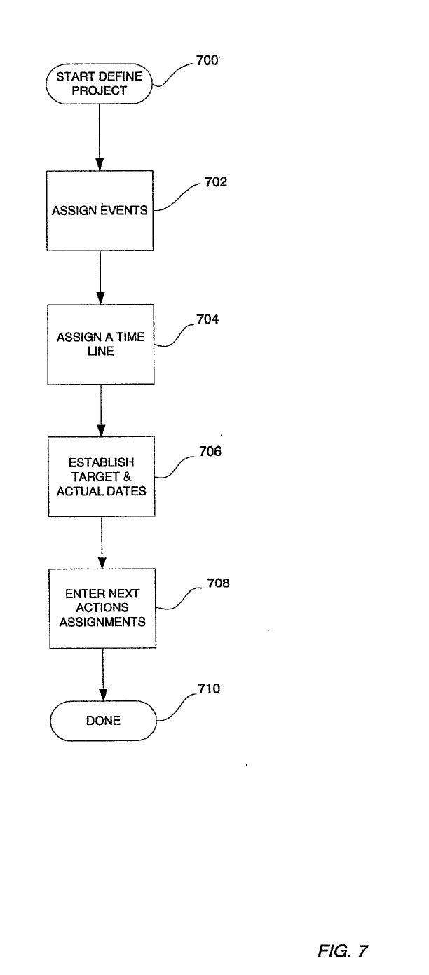

Turning now to FIG. 6, a flowchart setting forth the recursive logic of the process of entering information into the database of managing cases of the user interface component in accordance with the present invention will be described. Processing begins at block 600 where a request is received to enter person, organization, or project information at block 602. FIGS. 25-31 illustrates the step-by-step process for entering information into the database tables. From block 602, processing continues to decision block 604 where a determination is made as to whether information is for a project. If at block 604, it is determined that a user selects to enter information related to a project, processing continues to block 606 to define a project. The process of define project of process of entering information to define a project will be described in more detail with reference to FIG. 7 below.

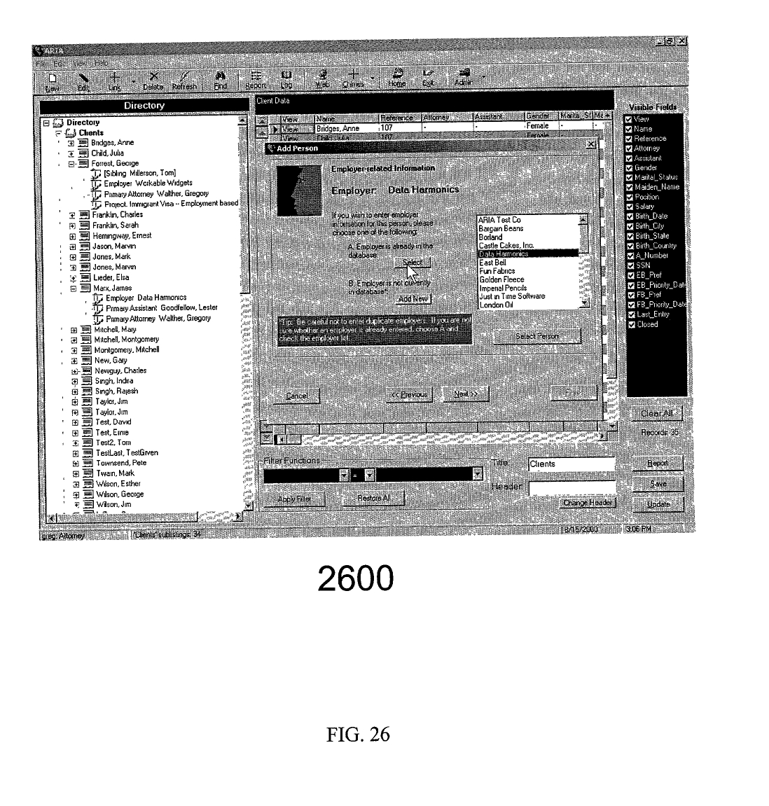

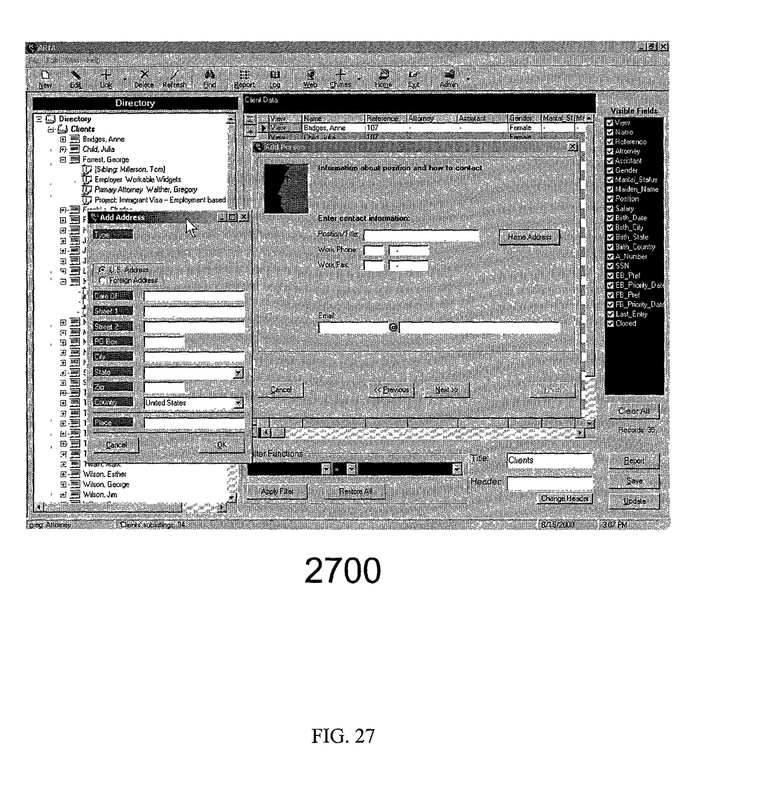

However, if at block 604 it is determined the information to enter is not project related, processing continues to block 608 to enter employer related information. FIG. 26 is a screen shot illustrating entering employer-related information into the database. FIG. 27 is a screen shot illustrating entering contact information into the database. Processing continues to block 610 to enter contact information. From block 610, processing continues to decision block 612 where a determination as to whether a user selects “Add” address. If at block 612, it is determined a user selects to enter an address, processing continues to block 614 to enter address related information.

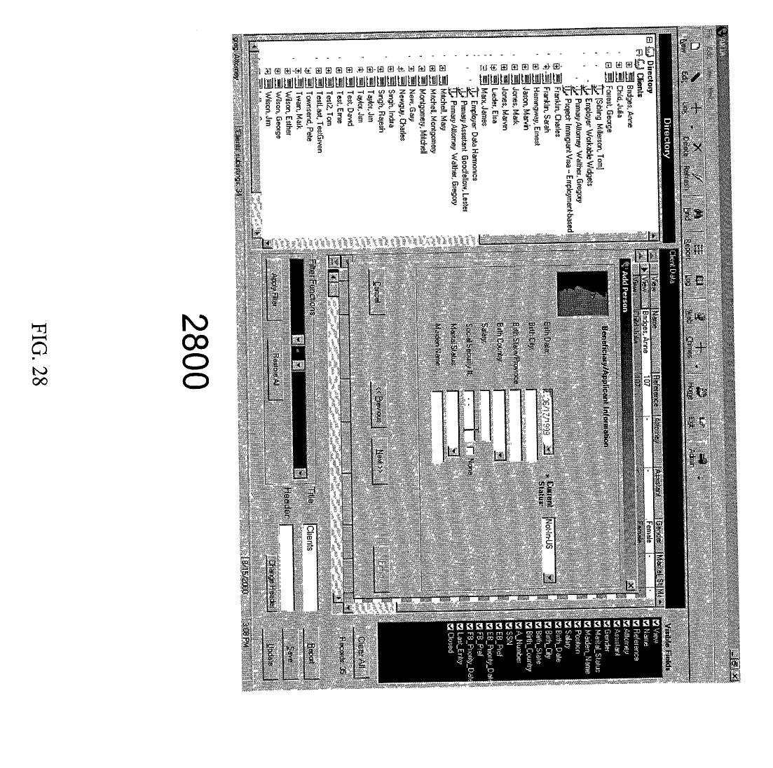

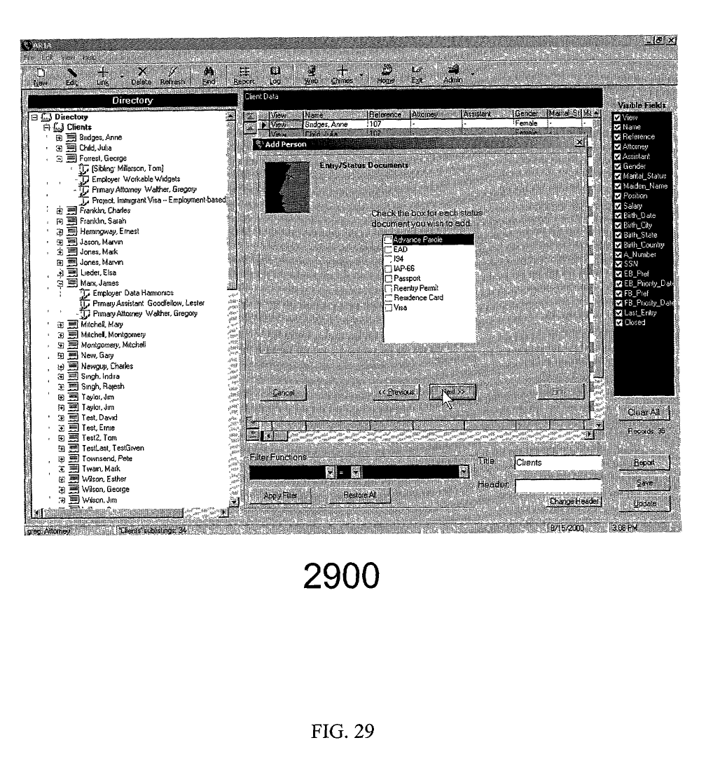

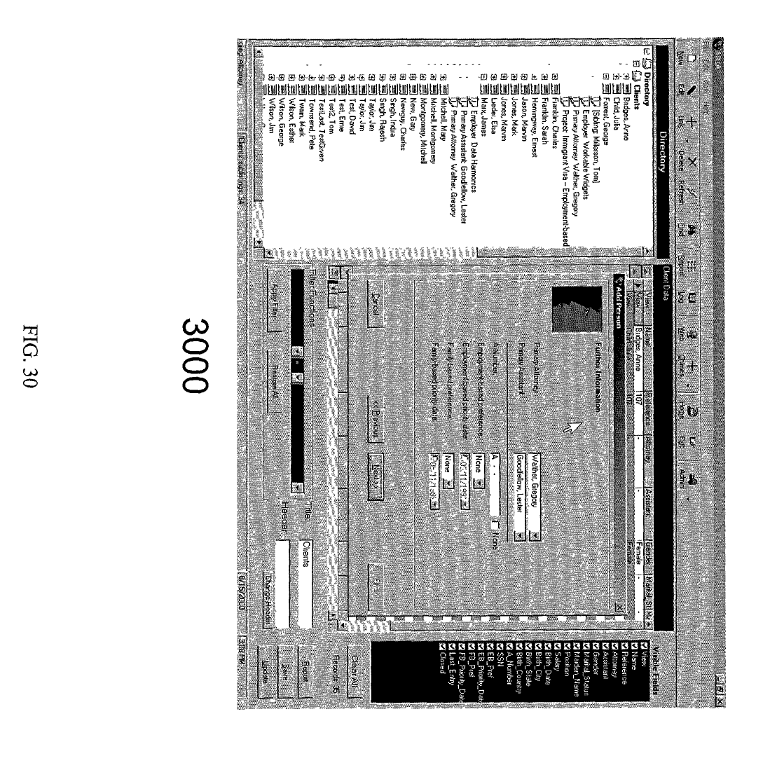

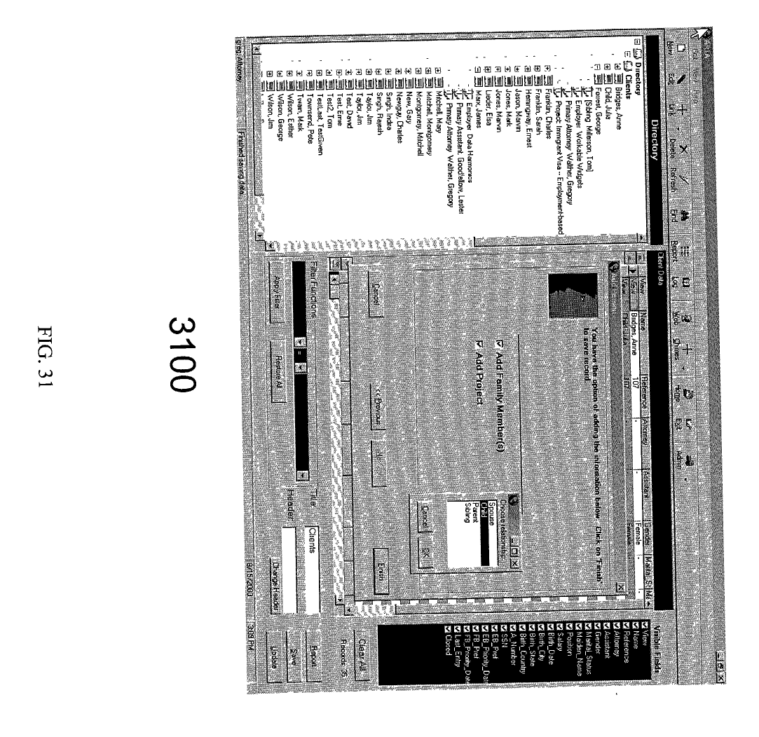

If at block 612, it is determined a user did not select “Add” address related information, processing continues to block 616 to enter beneficiary applicant related information. FIG. 28 is a screen shot illustrating entering beneficiary applicant related information into the database. From block 616 processing continues to block 618 where status document related information is entered. FIG. 29 is a screen shot illustrating entering status document related information into the database. From block 618, processing continues to block 620 to enter further information such as the assigning attorney. FIG. 30 is a screen shot illustrating entering assigning attorney information. Processing continues from block 620 to decision block 622 to add additional family members or projects. FIG. 31 is a screen shot illustrating entering additional family members or projects. If at block 622 it is determined additional information is added, processing returns to block 602 to enter person, organization or project related information and processing begins again.

If at block 622, it is determined that no additional information is added, processing continues to block 624 to save data in the database tables, and continues to block 626 where it ends.

FIG. 7 is a flowchart setting forth the detailed logic of entering information to define a project into the database of managing cases of the user interface component. Processing begins at block 700 to define a project. From block 700, processing continues to block 702 to assign events. As explained above, each project is preferably defined with five events and is associated with a timeline. The timeline breaks a project down into a series of key events. Once a project is created, a timeline is chosen and target dates are established. As the project progresses, actual dates upon which events were completed are entered into the database. A visual representation of the timeline on the project screen allows a user to quickly determine a projects status. As a result, a user can visually appreciate the overall progress of projects. From block 702, processing continues to block 704 to assign a timeline to a project. From block 704, processing continues to block 706 to establish target dates. From block 706, processing continues to block 708 to enter next action assignments. From block 708 processing continues to block 710 where it ends.

The present invention provides a method, system, computer-controlled apparatus, and computer-readable medium for automation and management of immigration case files, and more particularly the automation of tasks in managing the immigration case files by attorneys practicing in immigration law. While an actual embodiment of the invention has been illustrated and described, various changes can be made without departing from the spirit and scope of the invention.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. An immigration database management system for managing immigration related data stored in at least one database table comprising
(a) a user interface component that receives user requests;
(b) a logic component for controlling the processing of the immigration related data;
(c) a data access component for creating the connections to the database tables; and
(d) a server component for accessing and storing the data in the database tables.

2. The system of claim 1, wherein the user interface component for receiving user requests comprises of at least one of a plurality of document interface methods in VISUAL BASIC™.

3. The system of claim 1, wherein the server component for accessing and storing the data in the database tables comprises database management methods in SQL™.

4. The system of claim 3, wherein the server component for accessing and storing the data in the database tables comprises database management methods in MSJET™.

5. A method in a computer system for providing a user-interface component for receiving user inputs comprising:
while running an immigration database management system for managing immigration related data stored in one or more database tables, iteratively performing the steps (a)-(c):
(a) displaying a home screen;
(b) receiving one or more requests related to immigration case management; and in response to the requests displaying the results of the requests associated with the processing of immigration information; and
(c) managing immigration cases.

6. The method of claim 5, wherein the request includes one or more of:
(a) reminder;
(b) status documents;
(c) report menu;
(d) projects;
(e) standard reports;
(f) projects due;
(g) companies;
(h) page;
(i) timeline; and
(j) exit.

7. The method of claim 5, wherein the step of managing immigration cases comprises receiving a request to add a new article and in response to the request receiving and storing information associated with the new article.

8. The method of claim 7, wherein the article comprises a person; an organization; a project; a status document; a site; and a page.

9. The method of claim 7, wherein the step of receiving and storing information includes:
while running managing immigration cases, iteratively performing steps (a)-(d):
(a) obtaining person, organization or project information;
(b) determining whether the information entered is a project and in response to whether the information entered is a project:
(i) obtaining the employer related information;
(ii) obtaining the contact information;
(c) determining whether a user selects add address information and in response to whether a user selects add address information entering:
(i) beneficiary information;
(ii) status document information;
(iii) further information;
(d) determining whether a user selects to add additional family members or projects an in response to whether the user selects add additional family member or projects; storing the information in a database table.

10. The method of claim 9, further comprising:
in response to whether the information entered is a project; defining a project.

11. The method of claim 10, wherein the steps of defining a project includes:
(a) assigning events;
(b) assigning a timeline;
(c) assigning a target and actual dates; and
(d) assigning next actions.

12. The method of claim 11, wherein the step of assigning an event to a project further comprises an event for when a project is first opened.

13. The method of claim 11, wherein the step of assigning an event to a project further comprises an event for when a project is to proceed with preparation for filing.

14. The method of claim 11, wherein the step of assigning an event to a project further comprises an event for when a project is filed.

15. The method of claim 11, wherein the step of assigning an event to a project further comprises an event when a decision is received on a project.

16. The method of claim 11, wherein the step of assigning an event to a project further comprises an event for when a project is closed.
